(19) United States
(12) Patent Application Publication
(10) Pub. No.: US 2025/0115478 A1
(43) Pub. Date: Apr. 10, 2025

(54) PROCESS AND REACTOR DESIGN FOR THE CONVERSION OF CARBON DIOXIDE TO SYNTHESIS GAS

(71) Applicant: Flint Hills Resources, LP, Wichita, KS (US)

(72) Inventor: Khaled Atieh, Saint Paul, MN (US)

(73) Assignee: Flint Hills Resources, LP, Wichita, KS (US)

(21) Appl. No.: 18/909,479

(22) Filed: Oct. 8, 2024

Related U.S. Application Data
(60) Provisional application No. 63/543,108, filed on Oct. 9, 2023.

(51) Int. Cl. C01B 3/38

(52) U.S. Cl. CPC C01B 3/382; C01B 2203/0233; C01B 2203/0255; C01B 2203/0283; C01B 2203/0816; C01B 2203/1235

(57) ABSTRACT

A single-vessel reactor, a process, and a system for producing synthesis gas with improved carbon dioxide utilization, while decreasing operating and capital expenditures are disclosed. The single-vessel reactor, the process, and the system may provide for recycling carbon dioxide to generate synthesis gas with an ideal H₂:CO molar ratio for chemicals production and improved conversion of carbon dioxide to synthesis gas.

The present disclosure relates generally to a single-vessel reactor for producing synthesis gas with improved carbon dioxide utilization, while decreasing operating and capital expenditures. More particularly, the present disclosure provides a reactor, a process, and a system for generating synthesis gas in a single-vessel reactor for the conversion of carbon dioxide to synthesis gas with an ideal H₂:CO molar ratio.

### BACKGROUND

To facilitate reducing and/or avoiding high CO₂ emissions, carbon capture and utilization (CCU) processes have gained particular attention. CCU processes can be utilized as an addition to existing energy production facilities (e.g, oil refineries or power plants), where CO₂ can be used as a feedstock in synthesis of desirable chemicals (e.g., via the Fischer-Tropsch process), and effectively reduce CO₂ emissions.

A CCU process is tri-reforming of methane (TRM) or more broadly combined-reforming of methane (CRM). The TRM process is a synergistic combination of reactions, such as CO₂ reforming, steam reforming, and partial oxidation of methane, to generate synthesis gas. Synthesis gas is a gaseous mixture comprising hydrogen and carbon monoxide and may be used in the production of chemicals (e.g., methanol or ammonia), power generation, hydrogen-based fuels, petroleum-based products, and metal production. Synthesis gas can be produced from hydrocarbon-containing feedstocks (e.g., crude oil residuum, heavy oil, tar sand bitumen, natural gas, or biomass) and carbon dioxide gas streams. When utilizing renewable sources of hydrocarbons and energy, such as biomethane or biogas, and combining with carbon dioxide recycle and import, the TRM process can be an effective method towards net CO₂ reduction. The reactions for CO₂ tri-reforming, otherwise referred to as reverse water gas shift (rWGS), steam methane reforming (SMR), and partial oxidation of methane (POX), are as follows:

CO₂+H₂↔CO+H₂O (Equation 1)

CH₄+H₂O↔3H₂+CO (Equation 2)

CH₄+½O₂→CO+2H₂ (Equation 3)

Equation 1 is a rWGS reaction, Equation 2 is a SMR reaction, and Equation 3 is a POX reaction. Traditional SMR reactors for the production of synthesis gas at elevated H₂:CO ratios consist of a number of catalyst-filled tubes within a furnace or fired heater. This heat is externally supplied to the tubes by the combustion of fuels in burners in the furnace or fired heater. The fuels used (e.g., methane source) are typically hydrocarbon containing fuels, such as natural gas or fuel gas. As SMR units produce CO₂ at two-separate point sources, the fired heater and reaction-process side, there is a reduced efficiency to applying carbon capture and greater incurred costs. This is coupled with the fact that flue gas produced on the firing side is at low pressure, decreasing the thermodynamic efficiency of capturing CO₂ from the flue gas stream. In comparison, embodiments of the present disclosure provide a reactor design for the reforming of CO₂ that produces heat energy in-situ to the reactor process at high-pressure in a direct-fired manner. The result is greater thermal efficiency and a more cost-effective process flow and thermodynamic conditions for maximum CO₂ capture and conversion.

To generate synthesis gas useful for chemicals production, it is desirable for the generated synthesis gas to have a H₂:CO molar ratio between about 1:1 to about 2:1. To favor production of carbon monoxide (CO) and shift the H₂:CO molar ratio within the desired range, carbon dioxide can be added to the reaction mixture in a tri-reforming process scheme. Typically, TRM is also accompanied, in a CRM reaction scheme, by dry methane reforming (DMR) reaction (Equation 4) and/or a methanation reaction (Equation 5), which are as follows:

CH₄+CO₂↔2CO+2H₂ (Equation 4)

4H₂+CO₂↔CH₄+2H₂O (Equation 5)

However, carbon formation and deposition onto the catalysts in a TRM reactor can drastically reduce yield, efficiency, and life span of the catalyst. Two prevalent carbon formation reactions are the Boudouard reaction (Equation 6) and Methane Decomposition (Equation 7), which are as follows:

2CO↔C+CO₂ (Equation 6)

CH₄↔C+2H₂ (Equation 7)

Conversely, carbon may be destroyed and/or gasified in a TRM reactor to increase yield, efficiency, and life span of the catalyst. Because the Boudouard reaction (Equation 6) is reversible, an increase in carbon dioxide may drive equilibrium to increased CO formation, therefore further reducing an amount of carbon. Two other prevalent carbon destruction/gasification reactions are as follows:

C+O₂→CO₂ (Equation 8)

C+H₂O↔CO+H₂ (Equation 9)

Equation 8 may be referred to as “carbon combustion,” in which oxygen is reacted with carbon (e.g., carbon soot) to form carbon dioxide. Equation 9 may be referred to as “carbon gasification,” in which water is reacted with carbon to form carbon monoxide and hydrogen. As shown in Equations 6, 8, and 9, and increase in CO₂ may contribute to further reducing the extent of carbon formation.

Carbon formation may be dependent on various process conditions besides temperature, such as pressure. However, the Boudouard reaction is generally thermodynamically favorable at temperatures between 800-1400° F. and methane decomposition is thermodynamically favorable at temperatures above 1900-2200° F. Current CO₂ reforming reactor designs, processes, and systems thus involve separate reactor vessels to first generate synthesis gas of a higher H₂:CO molar ratio in a first reactor vessel (e.g., traditional SMR or Autothermal Reforming (ATR) designs), and then mixing a CO₂ rich gas stream with the first synthesis gas mixture to be fed into a second, downstream reactor vessel to produce synthesis gas of a desired H₂:CO molar ratio. Other process designs function by mixing CO₂ directly with the feed-stream to revamped or modified existing SMR units. This may not be an efficient use of CCU and may significantly increase capital expenditure (CAPEX) of such systems.

Processes based on Autothermal Reforming (ATR) have been previously considered as an alternative route to produce synthesis gas compared to Steam Methane Reforming (SMR). Traditionally, the main components of an ATR reactor are a burner, a combustion chamber, and a catalyst bed. In an ATR reactor, a POX reaction is followed by a SMR reaction in a fixed bed of the steam reforming catalyst. The catalyst bed drives the process reactions to approach equilibrium conditions. The ATR process operates at greater temperatures (e.g., 1850-2050° F.) and pressures (e.g., 30-100 bar) than SMR, and may thus require greater operating expenditure (OPEX). Additionally, some ATR processes and systems may require a first ATR reactor vessel and a separate downstream rWGS or DMR reactor vessel to facilitate the production of low H₂:CO molar ratio synthesis gas with minimal carbon formation, as described above. In conventional SMR and ATR systems that utilize Carbon Capture and Storage (CCS) to capture and geologically store carbon dioxide, a series of large and expensive compressors is used to increase the pressure of the carbon dioxide above critical pressure, thus improving the gas transport properties. The TRM process by comparison may recycle the captured CO₂ back to the reactor at anywhere between 10-40 bar, minimizing compressor requirements and associated costs. Therefore, SMR and ATR processes and systems may require a greater CAPEX to generate synthesis gas for CO₂ storage or chemical production from CO₂.

There is thus an unmet need to tailor a H₂:CO molar ratio in synthesis gas for desired downstream chemicals production, while optimizing conversion of hydrocarbon and carbon dioxide streams to generate synthesis gas in a cost-competitive manner. The present disclosure provides apparatuses, methods, and/or systems for generating synthesis gas in a process and energy efficient, compact, cost-effective manner that alleviates existing problems in industrial scale CO₂ utilization and synthesis gas production.

### SUMMARY

In some embodiments, the present disclosure provides a single-vessel reactor for conversion of carbon dioxide to synthesis gas, the single-vessel reactor comprising a partial oxidation zone comprising a burner to facilitate partial oxidation (POX), a catalytic zone downstream from the partial oxidation zone comprising a catalyst to facilitate steam methane reforming (SMR) and reverse water gas shift (rWGS) to equilibrium, an input for supplying a hydrocarbon-containing gas to the partial oxidation zone, an input for supplying oxygen to the partial oxidation zone, an input for supplying carbon dioxide gas to the single-vessel reactor, and an output from the catalytic zone for removing synthesis gas from the single-vessel reactor. In some embodiments, the single-vessel reactor additionally catalytically facilitates dry methane reforming (DMR) and methanation reactions in a combined reforming reaction scheme. In some embodiments, the carbon dioxide may be fed into a disengagement area residing within the partial oxidation zone located downstream of the burner flame area and before the start of the catalytic zone.

In some embodiments, the present disclosure provides a process for generating synthesis gas using a single-vessel reactor, the process comprising: supplying oxygen and a hydrocarbon-containing gas to a partial oxidation zone of a single-vessel reactor; reacting the oxygen and the hydrocarbon-containing gas in a partial oxidation (POX) reaction within the partial oxidation zone of the single-vessel reactor to form a first reaction mixture; supplying carbon dioxide gas to the single-vessel reactor; reacting the carbon dioxide and the first reaction mixture in steam methane reforming (SMR) and reverse water gas shift (rWGS) reactions within a catalytic zone of the single-vessel reactor comprising a catalyst to form a second reaction mixture comprising synthesis gas; and removing the second reaction mixture from the single-vessel reactor.

In some embodiments, the present disclosure provides a system for generating synthesis gas, the system comprising: a single-vessel reactor comprising: (i) a partial oxidation zone comprising a burner to facilitate partial oxidation (POX), (ii) a catalytic zone downstream from the partial oxidation zone comprising a catalyst to facilitate steam methane reforming (SMR) and reverse water gas shift (rWGS), and (iii) an output from the catalytic zone for removing synthesis gas and leftover carbon dioxide from an output reaction mixture from the single-vessel reactor; a hydrocarbon-containing gas input to the single-vessel reactor; an oxygen gas input to the single-vessel reactor; a feed-effluent unit configured to supply carbon dioxide gas to the single-vessel reactor; and a carbon capture unit downstream from the single-vessel reactor to separate the synthesis gas from the leftover carbon dioxide from the output reaction mixture from the output from the catalytic zone, treat the leftover carbon dioxide, and supply at least some of the treated leftover carbon dioxide back to the feed-effluent unit. In some embodiments, the partial oxidation zone may comprise a disengagement area located downstream of the burner flame area and before the start of the catalytic zone for receiving the carbon dioxide input stream.

### BRIEF DESCRIPTION OF DRAWING(S)

Further features and advantages of the disclosure can be ascertained from the following detailed description that is provided in connection with the drawings described below:

FIG. 1 is a schematic of an example single-vessel tri-reforming reactor for generating synthesis gas, consistent with some embodiments of the present disclosure.

FIG. 2 is a schematic of an example system for generating synthesis gas, consistent with some embodiments of the present disclosure.

FIG. 3 is an example of an equilibrium product distribution result for a dry methane reforming (DMR) reaction consistent with some embodiments of the present disclosure.

FIGS. 4A and 4B are modeled results of CO₂ conversion and CH₄ conversion via a DMR reaction over a range of temperatures and pressures consistent with some embodiments of the present disclosure.

FIG. 5 is an illustration of modeled results of carbon formation over a range of temperatures and pressures within a single-vessel reactor consistent with some embodiments of the present disclosure.

FIG. 6 is an illustration of modeled results of H₂:CO molar ratio in generated synthesis gas over a range of temperatures and pressures within a single-vessel reactor consistent with some embodiments of the present disclosure.

FIGS. 7A and 7B are modeled results of the number of moles of carbon deposited according to molar ratios of input gases to a single-vessel reactor at 1 bar pressure consistent with some embodiments of the present disclosure.

FIG. 8 is modeled kinetics of a DMR reaction and a reverse water gas shift (rWGS) reaction according to temperature in a single-vessel reactor consistent with some embodiments of the present disclosure.

FIG. 9A-9C are modeled results of a CO₂ reforming reaction in a conventional Autothermal reactor.

FIG. 10A-10C are modeled results of a CO₂ tri-reforming reaction in a single-vessel reactor, consistent with some embodiments of the present disclosure.

FIG. 11A-11C are modeled results of a CO₂ tri-reforming reaction in a single-vessel reactor, consistent with some embodiments of the present disclosure.

FIGS. 12A-12C are modeled results of a CO₂ tri-reforming reaction in a single-vessel reactor, consistent with some embodiments of the present disclosure.

FIG. 13 is a flowchart for a process for generating synthesis gas using a single-vessel reactor, consistent with some embodiments of the present disclosure.

### DETAILED DESCRIPTION

Some embodiments of the present disclosure may include a single-vessel reactor (for example a TRM or CRM reactor) that may produce synthesis gas at a competitive rate with other synthesis gas production technologies, and at a desired H₂:CO molar ratio. Table 1 below illustrates input requirements to generate synthesis gas and output of conventional systems incorporating SMR, ATR, and POX individually, and provides a comparison to some embodiments of the present disclosure. Notably, some embodiments of the present disclosure may have minimal requirement for steam as the TRM reactor is effective at destruction of soot precursors. Additionally, some embodiments of the present disclosure may produce synthesis gas at a rate ranging from 30-35 million standard cubic feet per day (MMSCFD), which is competitive to rates of SMR, ATR, and POX. Moreover, some embodiments of the present disclosure may produce synthesis gas with a H2:CO molar ratio ranging from 1:1 to 2:1 in a first pass through the reactor, which is lower than synthesis gas generated in a single pass through reactors of other conventional reactors, processes, and/or systems. This molar ratio in the generated synthesis gas may be ideal for downstream chemicals production, including but not limited to, dimethyl ether, methanol, and other chemicals produced via the Fischer-Tropsch process. Moreover, some embodiments of the present disclosure provide generated synthesis gas at temperatures above the Boudouard equilibrium temperature and below the methane decomposition temperature, thus avoiding carbon formation on catalysts within the single-vessel reactor of the present disclosure. Some embodiments of the present disclosure may also generate synthesis gas over a wide range of theoretical pressures (e.g., 1-30 bar), which may provide a lower OPEX compared to conventional systems and further alleviate carbon formation or deposition on catalysts within the single-vessel reactor. Some embodiments of the present disclosure maintain hotter partial oxidation flame temperatures, accelerate the destruction of soot precursors, minimize burner ignition delay, and minimize feed pre-heat energy requirement. The lower pre-heat requirement may potentially reduce or eliminate the need for fired furnaces to heat feed natural gas and oxygen. Thus, embodiments of the present disclosure may provide a more energy-efficient process, lower CAPEX and OPEX costs, and lower overall CO2 emissions.

TABLE 1

| | Comparative | Comparative | Comparative | Inventive |
|---|---|---|---|---|
| Technology | SMR | ATR | POX | Design |
| Hydrocarbon-containing | 10 | 10 | 10 | 10 |
| gas rate (MMSCFD) | | | | |
| CO2:Hydrocarbon | N/A | N/A | N/A | 0.05-1.0 |
| (mol/mol) | | | | |
| Steam:Hydrocarbon | 2.5-5 | 0.5-3.5 | 0-0.15 | 0.01-2.0 |
| (mol/mol) | | | | |
| O2:Hydrocarbon | 0 | 0.40-0.60 | 0.55-0.65 | 0.50-1.0 |
| (mol/mol) | | | | |
| Product synthesis gas | 35-40 | 35-40 | 30-35 | 30-35 |
| rate (MMSCFD) | | | | |
| Product synthesis gas | 3.0-4.0 | 2.5-3.5 | 1.5-2.5 | 1.0-2.0 |
| ratio (H2:CO) | | | | |
| Outlet Temperature | 1450-1600/ | 1850-2050/ | 2100-2700/ | 1400-1600/ |
| (° F.)/Pressure (bar) | 15-40 | 30-50 | 40-80 | 10-30 |

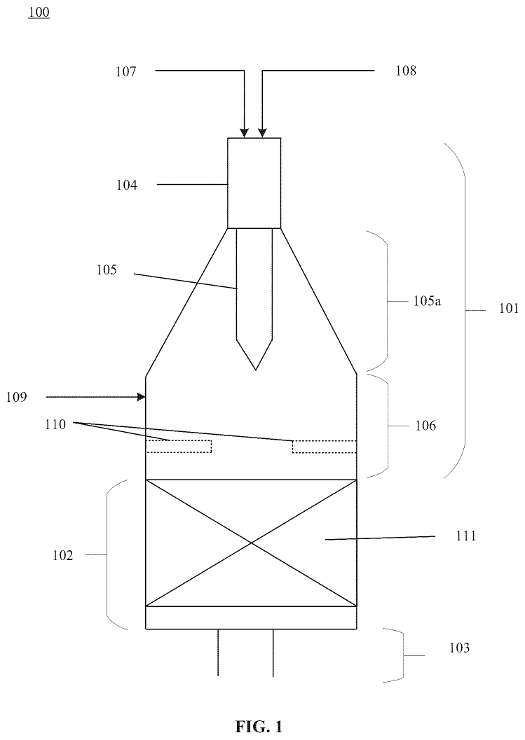

Reference is now made to FIG. 1, which is a schematic of an example single-vessel reactor, consistent with some embodiments of the present disclosure. It is appreciated that FIG. 1 is illustrative in nature, and should not be construed as limiting regarding relative size, shape, area, or volume of each component of the single-vessel reactor. FIG. 1 illustrates a single-vessel reactor 100 that may comprise a partial oxidation zone 101, a catalytic zone 102, and an output 103 from catalytic zone 102 for removing generated synthesis gas. Partial oxidation zone 101 may comprise a burner 104 to facilitate partial oxidation (Equation 3). As used herein, the term “zone” is used to mean a region having a particular characteristic, purpose, use, or restriction. As used herein, the term “partial oxidation zone” is used to mean a region of the single-vessel reactor for facilitating partial oxidation of a hydrocarbon-containing gas. As used herein, the term “catalytic zone” is used to mean a region of the single-vessel reactor for facilitating at least one of a steam methane reforming (SMR), reverse Water Gas Shift (rWGS), methanation, or dry methane reforming (DMR) reactions or all reactions. According to the present disclosure, the term “catalytic zone” is used to mean a zone downstream of the partial oxidation zone, which begins at the location where a catalyst is first located. As used herein, the term “facilitate” is used to mean making something possible, increasing the extent of, and/or increasing the rate of.

In some embodiments, burner 104 comprises a flame 105 with a flame area 105a. As used herein, the term “flame area” refers to the area within the partial oxidation zone that extends from the start of the flame closest to the burner to the end of the flame furthest from the burner. In some embodiments, burner 104 comprises a disengagement area 106 that may be located downstream of flame area 105a, between the end of the flame area 105a of the partial oxidation zone and before the start of the catalytic zone 102.

Reactor 100 may comprise an input 107 for supplying a hydrocarbon-containing gas to partial oxidation zone 101, an input 108 for supplying oxygen to partial oxidation zone 101, and an input 109 for supplying carbon dioxide gas to reactor 100. In some embodiments, input 109 may be configured to supply carbon dioxide gas to partial oxidation zone 101. In some embodiments, input 109 may be configured to supply carbon dioxide gas through burner 104. In some embodiments, input 109 may be configured to supply carbon dioxide gas through a side of the single-vessel reactor 100. In some embodiments, input 109 may be configured to supply carbon dioxide gas to disengagement area 106. Reactor 100 may optionally include an input for supplying steam. The input for steam may be a separate input, may be combined with input 107, or may be combined with input 109. The input for steam may be configured to supply steam to partial oxidation zone 101. In some embodiments, oxygen supplied to partial oxidation zone 101 by input 108 may be supplied from an Air Separation Unit (ASU). In some embodiments, oxygen may be supplied through electrolysis of water, with hydrogen from the electrolysis process used to supplement the hydrogen formed from the tri-reforming process, increasing the overall product syngas ratio.

Disengagement area 106 may be configured to facilitate mixing of input gases (e.g., hydrocarbon-containing gas and carbon dioxide gas). Disengagement area 106 may optionally include at least one physical component 110 to facilitate mixing of the hydrocarbon-containing gas and the carbon dioxide gas. In some embodiments, at least one physical component 110 may be a baffle, a checkered wall design of reactor 100, a choke ring, or any combination thereof. Additionally, it is appreciated that the cross-sectional area of disengagement area 106 may facilitate mixing of input gases. In some embodiments, the mixing may be facilitated by varying the cross-sectional area of the partial oxidation zone along its length in the downstream direction. In some embodiments, the partial oxidation zone 101 comprises an increase in cross-sectional area along its length in the downstream direction. In some embodiments, the portion of the single-vessel reactor comprising the flame area 105a may be narrower (e.g., smaller cross-sectional area) than the portion of the single-vessel reactor comprising the disengagement area 106.

Catalytic zone 102 may comprise a catalyst 111 that facilitates steam methane reforming (SMR) and reverse water gas shift (rWGS) reactions (e.g., Equations 1 and 2). In some embodiments, catalyst 111 may facilitate additional reactions, such as methanation and dry methane reforming (DMR) (e.g., Equation 4 proceeding from right to left and Equation 5). Catalyst 111 may be any catalyst known to be useful for catalyzing at least one of steam methane reforming (SMR) and reverse water gas shift (rWGS). In some embodiments, catalyst 111 is a catalyst useful for catalyzing both steam methane reforming (SMR) and reverse water gas shift (rWGS). In some embodiments, catalyst 111 may further facilitate at least one of methanation and dry methane reforming (DMR), or both. In some embodiments, the catalyst may be in the form of a catalytic bed. In some embodiments, catalyst 111 may comprise at least one metal, at least one ceramic, and at least one promoter. In some embodiments, the metal comprises passivated nickel, a noble metal, or a combination thereof. In some embodiments, the noble metal may be rhodium or ruthenium. In some embodiments, the ceramic comprises silica (SiO₂), alumina (Al₂O₃), cerium (CeO₂), or magnesium oxide (MgO). In some embodiments, the promoter comprises titanium, magnesium, or potassium. In some embodiments, catalyst 111 may comprise an optimal formulation (e.g., at least one metal, at least one ceramic, and at least one promoter) to be more thermally stable or resistant to sintering and decrease coke formation. In some embodiments, catalyst 111 may exhibit higher reaction activity and stabler long-term operation for syngas production.

Without being bound by theory, it is believed that supplying carbon dioxide gas through a side of single-vessel reactor 100 (e.g., to the disengagement area downstream of the flame area) may mitigate, prevent, or avoid carbon formation or carbon soot precursor formation from occurring on catalyst 111 in catalytic zone 102. Additionally, supplying carbon dioxide gas through a side of single-vessel reactor 100 (e.g., to the disengagement area downstream of the flame area) may facilitate a smaller reactor design. Feeding carbon dioxide through a burner may necessitate a larger reactor configured to provide a larger flame area (e.g., flame 105) to destroy carbon soot precursors. Nonetheless, feeding carbon dioxide through a burner may reduce complexity in reactor and system design, provide a minimal increase in CAPEX, and offer a heat recovery benefit from a recycled carbon dioxide stream. In contrast, feeding carbon dioxide to the disengagement area (e.g., through a side of a reactor) may beneficially maintain a hotter flame temperature for soot destruction and minimize preheat requirements for natural gas and oxygen to the burner. Feeding and staging carbon dioxide to the disengagement area (e.g., through the side of the reactor) may further hydrolyze and accelerate the destruction of soot precursors from the partial oxidization flame.

Input 109 for supplying carbon dioxide gas to single-vessel reactor 100 may be configured to pre-heat the carbon dioxide gas before entering reactor 100. In some embodiments, the carbon dioxide gas may be pre-heated to a temperature ranging from about 900 to about 1600° F., from about 1000 to about 1500° F., from about 1100 to about 1400° F., or from about 1200 to about 1300° F. In some embodiments, the carbon dioxide gas may be pre-heated to a temperature ranging from about 900 to about 1500° F., from about 900 to about 1400° F., from about 900 to about 1300° F., from about 900 to about 1200° F., from about 900 to about 1100° F., or from about 900 to about 1000° F. In some embodiments, the carbon dioxide gas may be pre-heated to a temperature ranging from about 1000 to about 1600° F., from about 1100 to about 1600° F., from about 1200 to about 1600° F., from about 1300 to about 1600° F., from about 1400 to about 1600° F., or from about 1500 to about 1600° F. In some embodiments, the carbon dioxide gas may be pre-heated to about 900, 950, 1000, 1050, 1100, 1150, 1200, 1250, 1300, 1350, 1400, 1450, 1500, 1550, or 1600° F. Each temperature or temperature range may be a separate embodiment.

Burner 104 of partial oxidation zone 101 may be configured to provide a flame 105 with flame area 105a with a temperature ranging from about 2300° F. to about 3600° F. In some embodiments, burner 104 may be configured to provide a flame with a temperature ranging from about 2400° F. to about 3500° F., from about 2500° F. to about 3400° F., from about 2600° F. to about 3300° F., from about 2700° F. to about 3200° F., from about 2800° F. to about 3100° F., or from about 2900° F. to about 3000° F. In some embodiments, burner 104 may be configured to provide a flame with a temperature ranging from about 2300° F. to about 3600° F., from about 2300° F. to about 3500° F., from about 2300° F. to about 3400° F., from about 2300° F. to about 3300° F., from about 2300° F. to about 3200° F., from about 2300° F. to about 3100° F., from about 2300° F. to about 3000° F., from about 2300° F. to about 2900° F., from about 2300° F. to about 2800° F., from about 2300° F. to about 2700° F., from about 2300° F. to about 2600° F., from about 2300° F. to about 2500° F., or from about 2300° F. to about 2400° F. In some embodiments, burner 104 may be configured to provide a flame with a temperature ranging from about 2400° F. to about 3600° F., from about 2500° F. to about 3600° F., from about 2600° F. to about 3600° F., from about 2700° F. to about 3600° F., from about 2800° F. to about 3600° F., from about 2900° F. to about 3600° F., from about 3000° F. to about 3600° F., from about 3100° F. to about 3600° F., from about 3200° F. to about 3600° F., from about 3300° F. to about 3600° F., from about 3400° F. to about 3600° F., or from about 3500° F. to about 3600° F. In some embodiments, burner 104 may be configured to provide a flame with a temperature of about 2300° F., about 2350° F., about 2400° F., about 2450° F., about 2500° F., about 2550° F., about 2600° F., about 2650° F., about 2700° F., about 2750° F., about 2800° F., about 2850° F., about 2900° F., about 2950° F., about 3000° F., about 3050° F., about 3100° F., about 3150° F., about 3200° F., about 3250° F., about 3300° F., about 3350° F., about 3400° F., about 3450° F., about 3500° F., about 3550° F., or about 3600° F. Each temperature or temperature range may be a separate embodiment.

Single-vessel reactor 100 may be configured to operate at a temperature ranging from about 1400° F. to about 2200° F. In some embodiments, single-vessel reactor 100 may be configured to operate at a temperature above the Boudouard soot formation temperature of about 1400° F., and below the decomposition temperature of methane (e.g., about 2200° F.). As used herein, the temperature of single-vessel reactor 100 includes the temperature of partial oxidation zone 101, catalytic zone 102, and outlet 103. In some embodiments, single-vessel reactor 100 may be configured to operate at a temperature ranging from about 1450° F. to about 2150° F., from about 1500° F. to about 2100° F., from about 1550° F. to about 2050° F., from about 1600° F. to about 2000° F., from about 1650° F. to about 1950° F., from about 1700° F. to about 1900° F., or from about 1750° F. to about 1850° F. In some embodiments, single-vessel reactor 100 may be configured to operate at a temperature ranging from about 1450° F. to about 2200° F., from about 1450° F. to about 2150° F., from about 1450° F. to about 2100° F., from about 1450° F. to about 2050° F., from about 1450° F. to about 2000° F., from about 1450° F. to about 1950° F., from about 1450° F. to about 1900° F., from about 1450° F. to about 1850° F., from about 1450° F. to about 1800° F., from about 1450° F. to about 1750° F., from about 1450° F. to about 1700° F., from about 1450° F. to about 1650° F., from about 1450° F. to about 1600° F., from about 1450° F. to about 1550° F., or from about 1450° F. to about 1500° F. In some embodiments, single-vessel reactor 100 may be configured to operate at a temperature ranging from about 1500° F. to about 2200° F., from about 1550° F. to about 2200° F., from about 1600° F. to about 2200° F., from about 1650° F. to about 2200° F., from about 1700° F. to about 2200° F., from about 1750° F. to about 2200° F., from about 1800° F. to about 2200° F., from about 1850° F. to about 2200° F., from about 1900° F. to about 2200° F., from about 1950° F. to about 2200° F., from about 2000° F. to about 2200° F., from about 2050° F. to about 2200° F., from about 2100° F. to about 2200° F., or from about 2150° F. to about 2200° F.

Single-vessel reactor 100 may be configured to operate at a pressure that may mitigate carbon/soot formation on a catalyst within reactor 100. In some embodiments, single-vessel reactor 100 may be configured to operate at a pressure ranging from about 1 bar to about 30 bar. In some embodiments, the pressure may range from about 3 bar to about 30 bar, from about 5 bar to about 30 bar, from about 7 bar to about 30 bar, from about 10 bar to about 30 bar, from about 15 bar to about 30 bar, from about 20 bar to about 30 bar, or from about 25 bar to about 30 bar. In some embodiments, reactor 100 may be configured to operate at a pressure ranging from about 1 bar to about 25 bar, from about 1 bar to about 20 bar, from about 1 bar to about 15 bar, from about 1 bar to about 10 bar, from about 1 bar to about 7 bar, from about 1 bar to about 5 bar, or from about 1 bar to about 3 bar. In some embodiments, reactor 100 may be configured to operate at a pressure ranging from about 3 bar to about 25 bar, from about 3 bar to about 20 bar, from about 3 bar to about 15 bar, from about 3 bar to about 10 bar, from about 3 bar to about 7 bar, or from about 3 bar to about 5 bar.

Some embodiments of the present disclosure provide supplying carbon dioxide gas to a side of single-vessel reactor 100 via input 109 where the supplied carbon dioxide does not participate in the flame chemistry of burner 104. It has surprisingly been found that supplying carbon dioxide gas to a side of reactor 100 can significantly alleviate carbon/soot formation or deposition within reactor 100. In comparison, and as done in conventional reactors and/systems, supplying carbon dioxide directly with the hydrocarbon-containing gas (e.g., natural gas or methane) into a burner (e.g., burner 104) may increase the propensity for soot formation due to less oxygen availability for partial oxidation of the hydrocarbon-containing gas and cooler flame temperatures. Instead, unreacted hydrocarbon (e.g., methane) may incur increased residence time in the flame (e.g., four seconds or longer), decompose into carbon or soot precursors (e.g., benzene, naphthalene, phenols, or acetylene) and therefore decrease yield and potentially poison the catalyst in the reactor. A larger reactor to facilitate a larger flame and/or an upstream heater to further pre-heat input streams may be used to mitigate the above. In comparison, by supplying carbon dioxide gas to a side of reactor 100 (e.g., via input 109 in FIG. 1), for example directly into disengagement area 106, it is possible to ensure that most of the hydrocarbon-containing gas is partially oxidized (e.g., Equation 3) and the carbon dioxide gas may be introduced below the methane decomposition temperature. Moreover, achieving adequate mixing of input gases through disengagement area 106 volume, cross-sectional area, residence time in flame area 105a, and potential use of internals in disengagement area (e.g., baffles, checkered wall design, or choke ring) may further improve the yield of reactions occurring within catalytic zone 102, particularly DMR (Equation 1).

Output 103 of reactor 100 may be configured to remove generated synthesis gas for subsequent processing. The generated synthesis gas may comprise H₂ and CO and may comprise a molar ratio of H₂ to CO ranging from about 1:1 to about 4:1. In some embodiments, the generated synthesis gas may comprise H₂ and CO at a molar ratio ranging from about 1:1 to about 3:1, from about 1:1 to about 2:1, from about 1.1:1 to about 2:1, from about 1.2:1 to about 2:1, from about 1.3:1 to about 2:1, from about 1.4:1 to about 2:1, from about 1.5:1 to about 2:1, from about 1.6:1 to about 2:1, from about 1.7:1 to about 2:1, from about 1.8:1 to about 2:1, or from about 1.9:1 to about 2:1. In some embodiments, the generated synthesis gas may comprise H₂ and CO at a molar ratio ranging from about 1:1 to about 2:1. In some embodiments, the generated synthesis gas may comprise H₂ and CO at a molar ratio ranging from about 1.4:1 to about 2:1. In some embodiments, the generated synthesis gas may comprise H₂ and CO at a molar ratio ranging from about 1.5:1 to about 2:1.

To mitigate carbon/soot formation that may poison catalysts used in single-vessel reactor 100, some embodiments of the present disclosure provide a range of compositions of input gases to be supplied to reactor 100. In some embodiments, inputs to reactor 100 (e.g., inputs 107-109) may be configured to supply oxygen gas and a hydrocarbon-containing gas such that a molar ratio of oxygen to the hydrocarbon ranges from about 0.4 to about 1. In some embodiments, the hydrocarbon in the hydrocarbon-containing gas comprises methane. In some embodiments, the hydrocarbon in the hydrocarbon-containing gas is methane. In some embodiments, the hydrocarbon-containing gas comprises one or more of natural gas, fuel gas, renewable natural gas, and biomethane. In some embodiments, the hydrocarbon-containing gas is natural gas.

In some embodiments, the amount of the oxygen may be sub stoichiometric compared to the amount of hydrocarbon within the hydrocarbon-containing gas. The molar ratio of oxygen to the hydrocarbon may range from about 0.4 to about 1, from about 0.45 to about 0.95, from about 0.5 to about 0.9, from about 0.55 to about 0.85, from about 0.6 to about 0.80, or from about 0.65 to about 0.75. In some embodiments, the molar ratio of oxygen to the hydrocarbon may range from about 0.45 to about 1, from about 0.5 to about 1, from about 0.55 to about 1, from about 0.6 to about 1, from about 0.65 to about 1, from about 0.7 to about 1, from about 0.75 to about 1, from about 0.8 to about 1, from about 0.85 to about 1, from about 0.9 to about 1, or from about 0.95 to about 1. In some embodiments, the molar ratio of oxygen to the hydrocarbon may range from about 0.4 to about 0.95, from about 0.4 to about 0.9, from about 0.4 to about 0.85, from about 0.4 to about 0.8, from about 0.4 to about 0.75, from about 0.4 to about 0.7, from about 0.4 to about 0.65, from about 0.4 to about 0.6, from about 0.4 to about 0.55, from about 0.4 to about 0.5, or from about 0.4 to about 0.45.

In some embodiments, inputs to reactor 100 (e.g., inputs 107-109) may be configured to supply carbon dioxide gas and a hydrocarbon-containing gas such that a molar ratio of carbon dioxide to the hydrocarbon ranges from about 0.05 to about 1.0. As described above, the hydrocarbon-containing gas may be natural gas and the hydrocarbon may be methane. In some embodiments, the molar ratio of carbon dioxide to hydrocarbon may range from 0.05 to about 1.0, from about 0.1 to about 0.95, from about 0.15 to about 0.9, from about 0.2 to about 0.85, from about 0.25 to about 0.8, from about 0.3 to about 0.75, from about 0.35 to about 0.7, from about 0.4 to about 0.65, from about 0.45 to about 0.6, or from about 0.5 to about 0.55. In some embodiments, the molar ratio of carbon dioxide to hydrocarbon may range from about 0.05 to about 1.0, from about 0.05 to about 0.95, from about 0.05 to about 0.9, from about 0.05 to about 0.85, from about 0.05 to about 0.8, from about 0.05 to about 0.75, from about 0.05 to about 0.7, from about 0.05 to about 0.65, from about 0.05 to about 0.6, from about 0.05 to about 0.55, from about 0.05 to about 0.5, from about 0.05 to about 0.45, from about 0.05 to about 0.4, from about 0.05 to about 0.35, from about 0.05 to about 0.3, from about 0.05 to about 0.25, from about 0.05 to about 0.2, from about 0.05 to about 0.15, or from about 0.05 to about 0.1. In some embodiments, the molar ratio of carbon dioxide to hydrocarbon may range from about 0.05 to about 1.0, from about 0.1 to about 1.0, from about 0.15 to about 1.0, from about 0.2 to about 1.0, from about 0.3 to about 1.0, from about 0.35 to about 1.0, from about 0.4 to about 1.0, from about 0.45 to about 1.0, from about 0.5 to about 1.0, from about 0.55 to about 1.0, from about 0.6 to about 1.0, from about 0.65 to about 1.0, from about 0.7 to about 1.0, from about 0.75 to about 1.0, from about 0.8 to about 1.0, from about 0.85 to about 1.0, from about 0.9 to about 1.0, or from about 0.95 to about 1.0.

As described above, reactor 100 may optionally comprise a separate input for supplying steam or steam may be co-fed with any one of inputs 107-109. In some embodiments, the molar ratio of steam supplied to reactor 100 to the hydrocarbon in the hydrocarbon-containing gas may range from about 0.01 to about 2.0. The hydrocarbon may be methane, and the hydrocarbon-containing gas may be natural gas. In some embodiments, the molar ratio of steam to hydrocarbon may range from about 0.05 to about 2.0, from about 0.1 to about 2.0, from about 0.15 to 2.0, from about 0.2 to about 2.0, from about 0.25 to about 2.0, from about 0.3 to about 2.0, from about 0.35 to about 2.0, from about 0.4 to about 2.0, from about 0.45 to about 2.0, from about 0.5 to about 2.0, from about 0.55 to about 2.0, from about 0.6 to about 2.0, from about 0.65 to about 2.0, from about 0.7 to about 2.0, from about 0.75 to about 2.0, from about 0.8 to about 2.0, from about 0.85 to about 2.0, from about 0.9 to about 2.0, from about 0.95 to about 2.0, from about 1.0 to about 2.0, from about 1.05 to about 2.0, from about 1.1 to about 2.0, from about 1.15 to about 2.0, from about 1.2 to about 2.0, from about 1.25 to about 2.0, from about 1.3 to about 2.0, from about 1.35 to about 2.0, from about 1.4 to about 2.0, from about 1.45 to about 2.0, from about 1.5 to about 2.0, from about 1.55 to about 2.0, from about 1.6 to about 2.0, from about 1.65 to about 2.0, from about 1.7 to about 2.0, from about 1.75 to about 2.0, from about 1.8 to about 2.0, from about 1.85 to about 2.0, from about 1.9 to about 2.0, or from about 1.95 to about 2.0. In some embodiments, the molar ratio of steam to hydrocarbon may have an upper limit of 2.0, 1.9, 1.8, 1.7, 1.6, 1.5, 1.4, 1.3, 1.2, 1.1., 1.0, 0.75, 0.50, or 0.25.

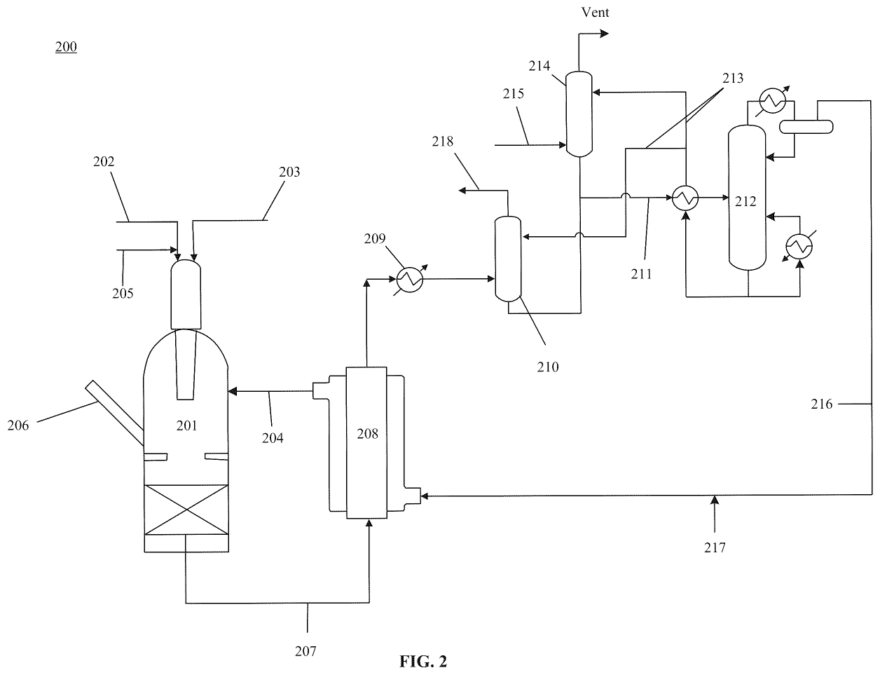

Reference is now made to FIG. 2, which is a schematic of an example system for generating synthesis gas, consistent with some embodiments of the present disclosure. System 200 illustrated in FIG. 2 may recycle leftover carbon dioxide from a single-vessel reactor (e.g., single-vessel reactor 100 of FIG. 1) back into the reactor to generate synthesis gas and utilize up to 97% of carbon dioxide upon multiple passes through the reactor, such as two passes. In some embodiments, system 200 may provide a single, combined, reactor scheme for TRM reactions and decrease CAPEX. In some embodiments, system 200 may provide improved heat and energy integration to reduce OPEX. In some embodiments, system 200 may provide industrial scale carbon capture and utilization and maximize carbon dioxide conversion to synthesis gas at 90% or greater conversion percentages upon multiple passes. In some embodiments, system 200 may provide a carbon dioxide net-negative technology and offer synthesis gas generation that has tailorable molar ratios of H₂:CO ranging from 1:1 to 2:1. In some embodiments, system 200 may be utilized to generated synthesis gas with larger H₂:CO molar ratios for downstream application.

System 200 may comprise a single-vessel reactor 201 (e.g., single-vessel reactor 100 of FIG. 1) that comprises an input 202 for a hydrocarbon-containing gas, an input 203 for oxygen gas, and an input 204 for carbon dioxide gas. In some embodiments, the hydrocarbon-containing gas may be any hydrocarbon-containing gas, for example natural gas, methane, biogas, or naptha. In some embodiments, reactor 201 may optionally include an input 205 for steam or steam may be co-fed with hydrocarbon-containing gas via input 202. FIG. 2 illustrates input 205 for supplying steam to reactor 201, but it is appreciated that some embodiments of the present disclosure are not so limited. Input 204 may supply carbon dioxide gas from a feed-effluent unit 208 (explained further below). The relative amounts (e.g., molar ratios) of each input gas may be as described above. In some embodiments, input 202 and input 203 may be configured to supply oxygen and a hydrocarbon-containing gas to reactor 201 at a molar ratio of from about 0.4:1 to about 0.8:1 (O₂:hydrocarbon). The reaction conditions of reactor 201 (e.g., temperature or pressure) may be as described above. A temperature sensor 206 may be coupled to reactor 201 and may be utilized to determine adjustments in the amount of hydrocarbon-containing gas supplied to reactor 201 via input 202. Likewise, temperature sensors and composition analyzers (not shown in FIG. 2) on the outlet stream 207 and/or downstream of exchanger 209 can be utilized to adjust inputs 202, 203 and, 205 (e.g., an amount of steam, an amount of O₂, and/or a target optimal syngas H₂:CO ratio) within the established operating envelopes.

An output stream 207 exiting an output of reactor 201 may comprise generated synthesis gas, leftover carbon dioxide, or a combination thereof. Output stream 207 may be supplied to feed-effluent unit 208. Feed-effluent unit 208 may comprise two chambers in which to receive leftover carbon dioxide in output stream 207 and to pre-heat concentrated carbon dioxide supplied to reactor 201. It is appreciated that while leftover carbon dioxide in output stream 207 is discussed in this disclosure, other leftover product species in output stream 207 may be received in and/or pre-heated by feed-effluent unit 208, and/or recycled in system 200. In some embodiments, feed-effluent unit 208 may comprise a heater to pre-heat carbon dioxide to supply to reactor 201 via input 204. In some embodiments, heat from output stream 207 may be used to pre-heat carbon dioxide to supply to reactor 201 via input 204. Output stream 207 may pass through feed-effluent unit 208 and pass through a heat exchanger 209. In some embodiments, heat exchanger 209 may be a cooler or waste heat boiler design. In some embodiments, output stream 207 may be cooled such that heat contained in output stream 207 may be captured. In some embodiments, heat may be captured from output stream 207 via generated steam. The generated steam may be supplied elsewhere in system 200 to improve system efficiency. In some embodiments, the generated steam may be recycled to an input for supplying steam to reactor 201 (e.g., via input 202 or via a separate input for supplying steam, such as, e.g., input 205). In some embodiments, the generated steam may be supplied to a downstream steam-driven component (e.g., a steam-driven pump or a boiler). In some embodiments, the generated steam may be supplied to provide heat to oxygen gas or hydrocarbon-containing gas to be supplied to reactor 201 (e.g., via input 203 or input 202). In some embodiments, output stream 207 may be used to pre-heat the hydrocarbon-containing gas (e.g., input 202) and/or the oxygen gas (e.g., input 203) via heat exchangers similar to an arrangement as illustrated for feed-effluent unit 208. In some embodiments, output stream 207 may be used to pre-heat input 202 and input 203 via a pre-heat exchanger. In some embodiments, output stream 207 may be used to pre-heat input 202 and input 203 via a fuel fired furnace or an electric heater.

Output stream 207 may be supplied to a carbon capture unit, in which the generated synthesis gas may be separated from the leftover carbon dioxide in output stream 207 and the leftover carbon dioxide may be treated. As used herein, the terms “treating,” “treatment,” or “treated” may be understood to mean removal of an impurity in an input or output stream and/or increase of the mole fraction of a desired species or component (e.g., carbon dioxide) in an input or output stream. In some embodiments, the carbon capture unit may be positioned downstream of feed-effluent unit 208. In some embodiments, the carbon capture unit may be positioned downstream of feed-effluent unit 208 and heat exchanger 209. The carbon capture unit may be any component or combination of components useful in cleaning generated synthesis gas and separating synthesis gas from additional components (e.g., carbon dioxide). In some embodiments, the carbon capture unit may be an acid gas removal component, a chemical solvent system (e.g., diethanolamine, monoethanolamine, methyl diethanolamine, or other amines used in gas treating), a solid absorbent system (e.g., pressure swing absorption), or a physical solvent system (e.g., Rectisol® or Selexol®). In some embodiments, the carbon capture unit is an amine-based system. In some embodiments, the amine-based carbon capture unit comprises a separator/absorber 210 and a regenerator 212. In some embodiments, the amine-based carbon capture unit comprises a separator/absorber 210, a regenerator 212, and a second separator/absorber 214. As used herein, the term “separator/absorber” refers to a process equipment unit that performs one or both of the tasks of separation and/or absorption of components of a process stream.

In some embodiments, one or both of the separator/absorbers 210 and 214 may be synthesis gas scrubbers. In some embodiments, one or both of the separator/absorbers 210 and 214 may be a chemical solvent system using an amine to absorb leftover carbon dioxide from output stream 207. In some embodiments, separator 210 may absorb carbon dioxide from output stream 207 and supply the absorbed, leftover carbon dioxide stream 211 to regenerator 212. In some embodiments, regenerator 212 may be an amine unit. In some embodiments, the amine unit may be an amine regenerator. In some embodiments, regenerator 212 strips the absorbed carbon dioxide from leftover carbon dioxide stream 211. In some embodiments, regenerator 212 may generate a regenerated absorber stream 213, in which regenerated absorber stream 213 may be formed after the absorbed carbon dioxide is stripped from leftover carbon dioxide stream 211. Regenerated absorber stream 213 may be recycled back to separator 210. In some embodiments, regenerated absorber stream 213 may be supplied to the second separator/absorber 214.

In some embodiments, second separator/absorber 214 may be utilized to receive an external carbon dioxide stream 215 (such as a low concentration carbon dioxide stream), in which external carbon dioxide stream 215 may be supplied from an external carbon dioxide concentration source. Low concentration carbon dioxide stream 215 may have 50% or less carbon dioxide, for example from 20% to 50%. In some embodiments, low concentration carbon dioxide stream 215 may be sequestered. In some embodiments, low concentration carbon dioxide stream 215 may be supplied directly to reactor 201. In some embodiments, low concentration carbon dioxide stream 215 may be supplied to a side of reactor 201 (e.g., via input 204). The low concentration carbon dioxide source may be from a carbon dioxide hub. The carbon dioxide hub may be flue gas coming from an output of oil refineries, power plants, metal industry plants, or other fossil-fuel based energy production or textile manufacturing sources and the like. Separator/absorber 214 may use the regenerated amine from regenerated stream 213 to absorb carbon dioxide from external carbon dioxide stream 215. In some embodiments, separator/absorber 214 outputs an absorbed carbon dioxide stream to be combined with the absorbed leftover carbon dioxide stream 211.

Regenerator 212 may generate a recycled carbon dioxide stream 216. As illustrated in FIG. 2, recycled carbon dioxide stream 216 comprises treated leftover carbon dioxide from the output reaction mixture from the output from the catalytic zone, which may be recycled back to feed-effluent unit 208. In some embodiments, an external carbon dioxide stream 217 may be supplied to combine with carbon dioxide stream 216, for example from a high concentration carbon dioxide source. In some embodiments, low concentration carbon dioxide stream 215 may be supplied to combine with carbon dioxide stream 216. High concentration carbon dioxide stream 217 may have a concentration of more than 50% carbon dioxide, for example more than about 75%, more than about 85%, or more than about 95%. The high concentration carbon dioxide source may be from a carbon dioxide hub or pipeline (not shown). The carbon dioxide hub or pipeline may be any additional external source of carbon dioxide, for example, from the output of oil refineries, power plants, metal industries, and other fossil-fuel based energy production or textile manufacturing sources. In some embodiments, external carbon dioxide stream 217 may be combined with recycled carbon dioxide stream 216. In some embodiments, regenerator 212 may be configured to provide carbon dioxide back to the feed-effluent unit at a concentration of about 50 to about 99% carbon dioxide. In some embodiments, regenerator 212 may be configured to provide carbon dioxide back to the feed-effluent unit at a concentration of about 50 to about 95% carbon dioxide, for example from about 75 to about 95%, or from about 85 to about 95%. Recycled carbon dioxide stream 216 may be pre-heated as described above and supplied to input 204 to recycle carbon dioxide back to reactor 201.

In some embodiments, system 200 may convert from about 25% to about 50% of carbon dioxide (e.g., carbon dioxide supplied via input 204) to synthesis gas in a first pass through reactor 201, for example from about 40% to about 50%. As used herein, description of the conversion of carbon dioxide on a first pass refers to the percentage of an amount of carbon dioxide gas initially supplied to reactor 201 that is reacted to generate synthesis gas by the time the generated synthesis gas exits the reactor in output stream 207. In some embodiments, recycling treated carbon dioxide back to reactor 201 as described above for a second pass through 201 may convert up to about 97% of carbon dioxide to synthesis gas. In some embodiments, recycling treated carbon dioxide back to reactor 201 as described above for a second pass through 201 may convert from about 50% to about 97% of the initial amount of carbon dioxide to synthesis gas, for example from about 60% to about 97%, or from about 75% to about 95%.

Referring back to separator 210, a separate synthesis gas output stream 218 may exit separator/absorber 210. In some embodiments, synthesis gas stream 218 may be used for downstream chemicals production (e.g., methanol, dimethyl ether, or other chemicals produced via the Fischer-Tropsch process). In some embodiments, synthesis gas output stream 218 may be supplied to an adjustment reactor or adjustment system (not shown in FIG. 2). In some embodiments, the adjustment reactor may facilitate adjusting the H₂:CO molar ratio in the separate synthesis gas output stream 218. In some embodiments, the adjustment reactor may facilitate a reverse water-gas shift reaction (e.g., Equation 1) to increase the H₂:CO molar ratio in the separate synthesis gas output stream 218. In some embodiments, the adjustment reactor may be positioned downstream of exchanger 209 and upstream of the carbon capture unit (e.g., upstream of separator 210). In some embodiments, the adjustment reactor may be positioned downstream of feed-effluent unit 208 and upstream of the carbon capture unit (e.g., upstream of separator 210). In some embodiments, the adjustment reactor positioned downstream of feed-effluent 208 and upstream of the carbon capture unit may utilize heat capture in output stream 207 to produce additional carbon dioxide with greater efficiency. In some embodiments, the adjustment system may be either a Pressure Swing Adsorbent (PSA) unit or membrane technology downstream of a syngas upgrading unit. In some embodiments, the adjustment system recycles product hydrogen to separate synthesis gas output stream 218, increasing the product syngas H₂:CO molar ratio. In some embodiments, the use of an adjustment system, such as for example a PSA or membrane equipment, allows for maximizing an amount of carbon dioxide recycled to reactor 201, while still meeting higher syngas H₂:CO molar ratio requirements for certain chemicals production such as methanol.

In some embodiments, system 200 may include a pre-reforming reactor upstream (not shown) of hydrocarbon-containing gas input 202. The pre-forming reactor may be configured to convert heavier hydrocarbons in a hydrocarbon-containing gas to methane. In some embodiments, the heavier hydrocarbons may comprise at least one of ethane, pentane, or butane.

Example equilibrium and Gibbs minimization modeling parameters for system 200 are provided in Tables 2-4 below, consistent with some embodiments of the present disclosure. The modeling was created using ProMax. Table 2 provides example modeled parameters for input hydrocarbon-containing gas and oxygen gas (e.g., via hydrocarbon-containing gas input 202 and oxygen input 203 of FIG. 2). As seen in Table 2, both input gases may comprise 100% methane and 100% oxygen, respectively. A standard vapor volumetric flow rate may be 1 MMSCFD and 0.60 MMSCFD for the hydrocarbon-containing gas and the oxygen gas, respectively. The input gases may be supplied to a single-vessel reactor (e.g., single-vessel reactor 100 of FIG. 1 or single-vessel reactor 201 of FIG. 2). Table 3 provides example modeled parameters for carbon dioxide gas from an external stream (e.g., external carbon dioxide stream 217 in FIG. 2) and for input carbon dioxide gas (e.g., input 204 of FIG. 2) supplied to a single-vessel reactor (e.g., single-vessel reactor 100 of FIG. 1 or single-vessel reactor 201 of FIG. 2). The carbon dioxide from an external stream may be combined with a recycled carbon dioxide stream (e.g., recycled carbon dioxide stream 216 of FIG. 2) at a standard vapor volumetric flow of 0.3 MMSCFD and at a temperature of 200° F. Example compositions of the carbon dioxide from an external stream may be 90% CO₂ and 10% H₂O. In comparison, input carbon dioxide to the reactor may be supplied at a temperature of 1400° F., a pressure of 15 bar, and a standard vapor volumetric flow rate of 0.63 MMSCFD. An example composition of the input carbon dioxide may be 95.2% CO₂ and 4.76% H₂O. The input carbon dioxide may be heated as described above.

Table 4 provides example parameters for a reaction mixture of gases in a single-vessel reactor (e.g., reactor 101 of FIG. 1 or reactor 201 of FIG. 2). The values presented in Table 4 may correspond to a reaction mixture in a partial oxidation zone of the single-vessel reactor (e.g., partial oxidation zone 101 of FIG. 1). Table 5 provides example parameters for an output gas stream from a catalytic zone of a single-vessel reactor (e.g., catalytic zone 102 of FIG. 1). Notably, Table 4 indicates the reaction mixture in the partial oxidation zone may contain a mole fraction of 12.4 CO₂, whereas Table 5 indicates the output gas stream (e.g., generated synthesis gas) may contain a mole fraction of 7.09 CO₂. This may correspond to a first-pass through the single-vessel reactor, and equals a 43.2% conversion of CO₂ to synthesis gas. The H₂:CO molar ratio in Table 5 is around 1.5, which may be ideal for downstream chemicals production as described above. A temperature of the output gas stream in Table 5 may be 1744.3° F., and heat from the output gas stream may be captured and recycled to the single-vessel reactor or to other components of the system of the present disclosure, as described above. Table 6 provides example parameters for a separated synthesis gas mixture (e.g., separated synthesis gas output stream 218 of FIG. 2), in which CO₂ may be completely removed from the synthesis gas mixture. As seen in Table 6, a modeled H₂:CO molar ratio is around 1.5, which may thus be utilized in chemicals production applications.

TABLE 2

| Properties | Hydrocarbon-containing gas | Oxygen gas |
|---|---|---|
| Standard Vapor Volumetric | 1 | 0.60 |
| Flow (MMSCFD) | | |
| Composition (%) | CH₄: 100 | O₂: 100 |

TABLE 3

| | CO₂ gas from | Input CO₂ gas |
|---|---|---|
| Properties | external | to reactor |
| Pressure (bar) | N/A | 15 |
| Temperature (° F.) | 200 | 1400 |
| Composition (%) | CO₂: 90; H₂O: 10 | CO₂: 97.1; H₂O: 2.88 |
| Molar Flow (lbmol/hr) | 29.646 | N/A |
| Standard Vapor Volumetric | N/A | 0.63 |
| Flow (MMSCFD) | | |

TABLE 4

| | Reaction Mixture in |
|---|---|
| Properties | partial oxidation zone |
| Standard Vapor Volumetric | 3.58 |
| Flow (MMSCFD) | |
| Temperature (° F.) | 1821.5 |
| Pressure (bar) | 15 |
| Composition (%) | CH₄: 0.707 |
| | CO₂: 18.1 |
| | CO: 25.9 |
| | H₂: 49.5 |
| | H₂O: 5.81 |

TABLE 5

| Properties | Output gas stream |
|---|---|
| Standard Vapor Volumetric | 3.55 |
| Flow (MMSCFD) | |
| Temperature (° F.) | 1721.9 |
| Composition (%) | CH₄: 1.07 |
| | CO₂: 9.28 |
| | CO: 34.7 |
| | H₂: 39.8 |
| | H₂O: 15.1 |
| CO₂ Molar Flow (lbmol/hr) | 36.221 |

TABLE 6

| | Separated Synthesis |
|---|---|
| Properties | gas Mixture |
| Standard Vapor Volumetric | 3.22 |
| Flow (MMSCFD) | |
| Temperature (° F.) | 200 |
| Composition (%) | CH₄: 1.18 |
| | CO₂: 0 |
| | CO: 38.2 |
| | H₂: 43.9 |
| | H₂O: 15.1 |

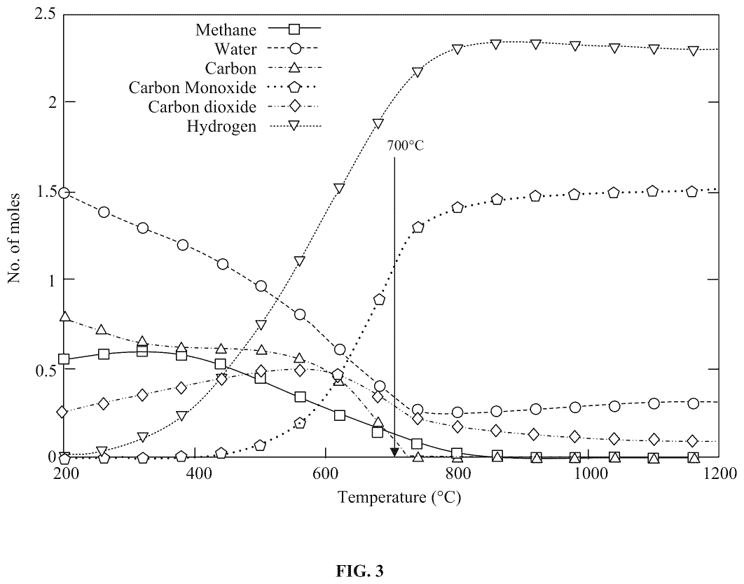

FIGS. 3-8 depict kinetic and thermodynamic analyses of tri-reforming reactions that may be utilized to understand how those reactions may be applied according to embodiments of the present disclosure. The analyses were reported in “Kinetic and Thermodynamic Analysis of Combined Dry, Steam and Partial Oxidation Reforming of Methane” by Mohamed Sufiyan; Office of Graduate and Professional Studies of Texas A&M University (May 2016).

Reference is now made to FIG. 3, which is an example equilibrium product distribution versus temperature in a combined-reforming of methane (CRM) reaction, consistent with some embodiments of the present disclosure. The CRM reactions are presented above (e.g., Equations 1-5). FIG. 3 illustrates a plot of a number of moles of chemical species from the CRM reactions versus temperature. The chemical species plotted are CH₄, H₂O, C (carbon), CO, CO₂, and H₂. FIG. 3 illustrates that above 700° C., the modeled CRM reactions significantly favors formation of H₂ and CO. Specifically, above 700° C. at 1 bar, FIG. 3 demonstrates that a H₂:CO molar ratio of the generated synthesis gas may range from about 1.4 to 2.0. Moreover, above 700° C., the formation of carbon drops significantly. Therefore, the modeled results illustrated in FIG. 3 provide justification for a single-vessel reactor (e.g., reactor 101 of FIG. 1 or reactor 201 of FIG. 2) to operate at a temperature at or above 700° C. to be ideal for conversion of CH₄ and CO₂ to H₂ and CO, minimize carbon formation, and target a synthesis gas with an ideal molar ratio for chemicals production.

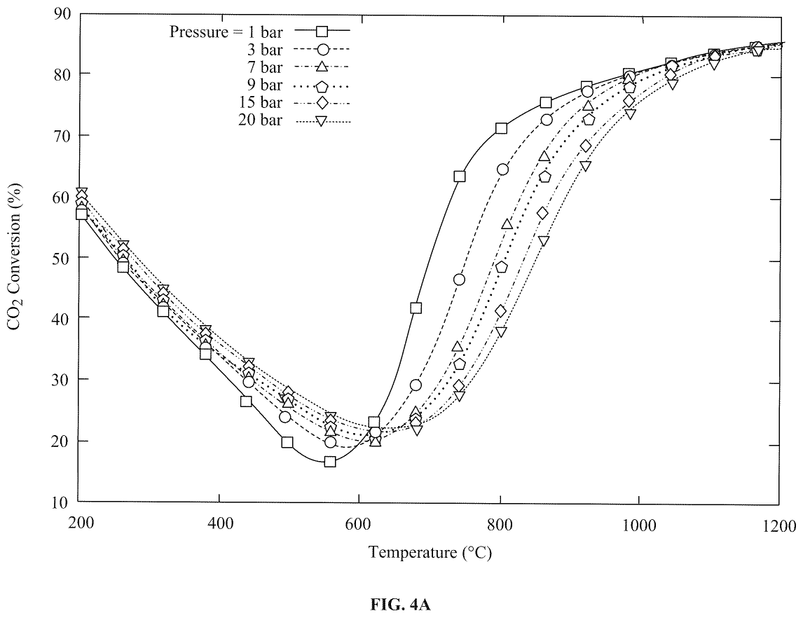

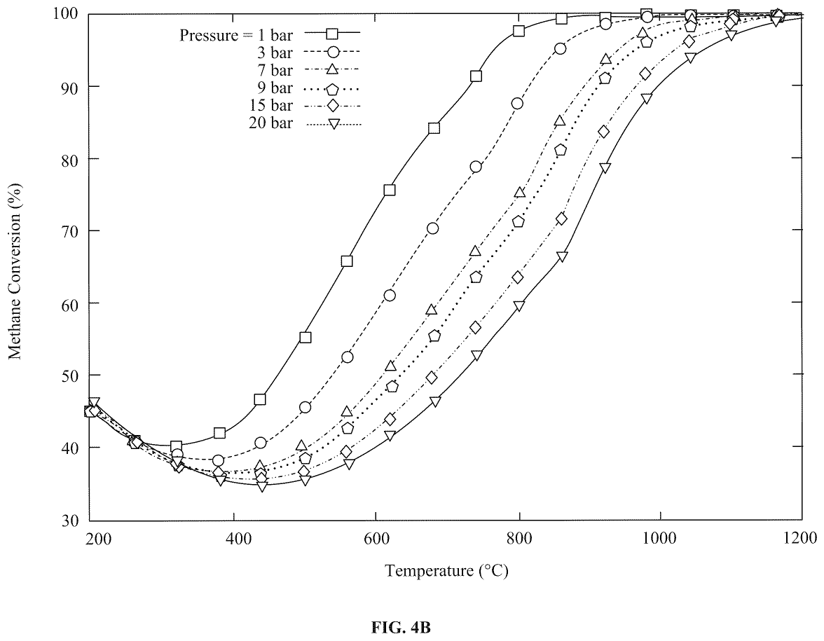

Reference is now made to FIG. 4A and FIG. 4B, which illustrates modeled results of CO₂ conversion (FIG. 4A) and CH₄ conversion (FIG. 4B) via CRM reactions over a range of temperatures and pressures, consistent with some embodiments of the present disclosure. In both FIG. 4A and FIG. 4B, decreasing a pressure in a single-vessel reactor increases the conversion percentage of CO₂ and methane. At lower temperatures of about 700° C., about a 50% conversion of CO₂ and about a 70% conversion of methane is possible with a pressure of 3 bar. Therefore, FIGS. 4A and 4B demonstrate that lower pressures and higher temperatures in a single-vessel reactor is favorable for methane and CO₂ conversion.

Reference is now made to FIG. 5, which illustrates modeled results of carbon-soot formation over a range of temperatures and pressures within a single-vessel reactor, consistent with some embodiments of the present disclosure. In general, the lower the pressure at temperatures above 600° C., the lower the carbon-soot formation. FIG. 5 may illustrate a number of moles of carbon formed via methane decomposition and/or CO decomposition via the Boudouard reaction. FIG. 5 illustrates that at any pressure modeled, the number of moles of carbon formed decreases with an increase in temperature. However, as the pressure decreases to 1 or 3 bar, carbon formation is minimized at lower temperatures. Specifically, carbon formation at 800° C. is decreased by about half when an operating pressure of 9 bar is used instead of an operating pressure of 15 bar. These modeled results provide justification to, in some embodiments, operate a single-vessel reactor of the present disclosure at pressure as low as practical depending on overall system requirements.

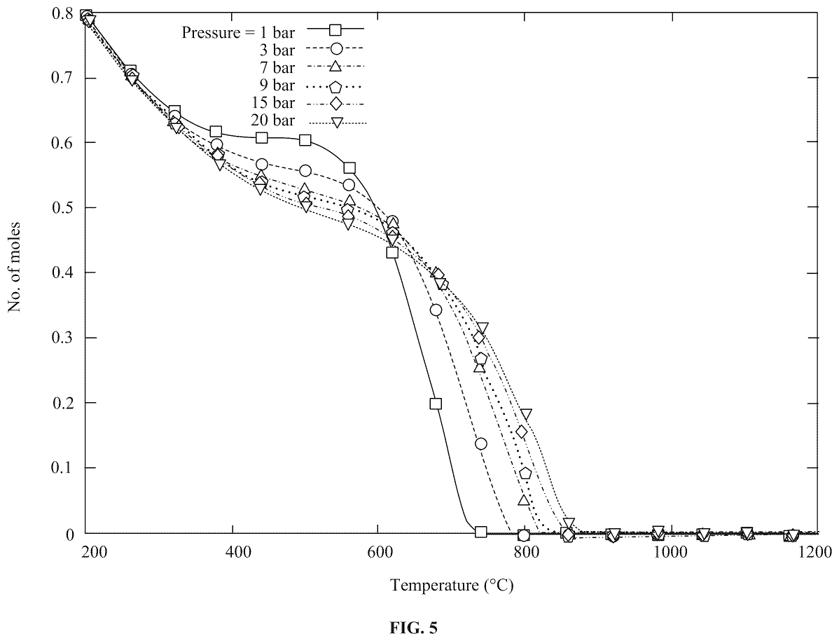

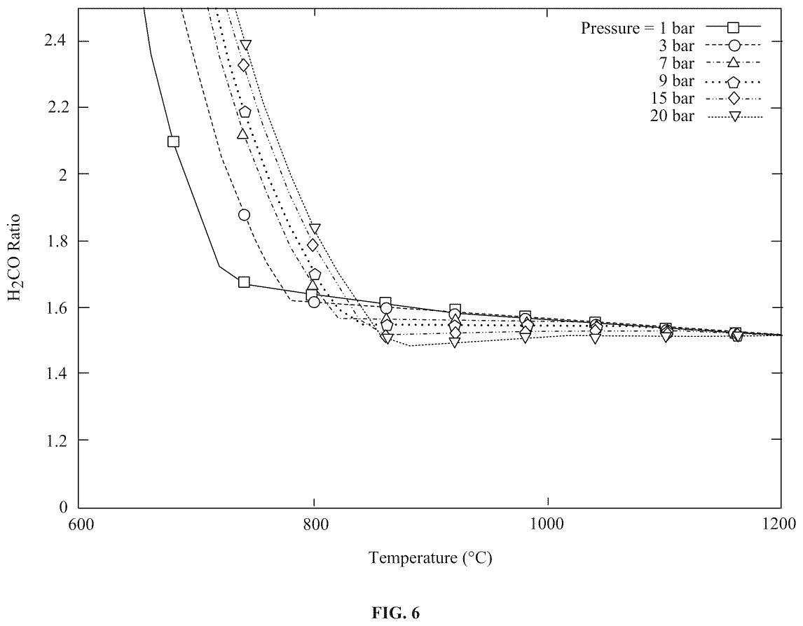

Reference is now made to FIG. 6, which illustrates modeled results of H₂:CO molar ratio in generated synthesis gas over a range of temperatures and pressures within a single-vessel reactor, consistent with some embodiments of the present disclosure. The synthesis gas was generated from input gas molar ratios of 1:0.6:0.1:0.6 (CH₄:H₂O:O₂:CO₂). FIG. 6 demonstrates that as pressure decreases, a lower H₂:CO molar ratio may be achieved in the generated synthesis gas at lower temperatures. For example, when the operating pressure in the single-vessel reactor is 15 bar, a H₂:CO molar ratio of around 1.8 may be achieved at 800° C. Temperature, pressure and molar feed compositions can be optimized for target syngas ratio and desired chemical synthesis.

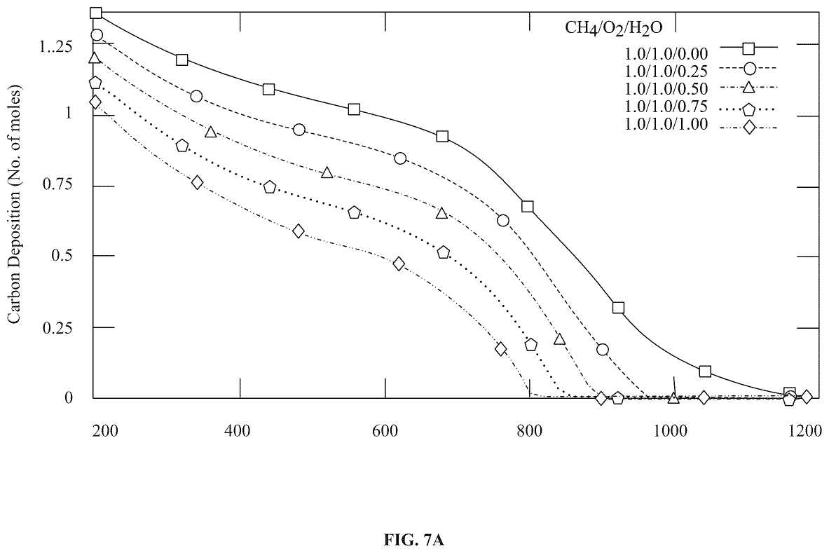

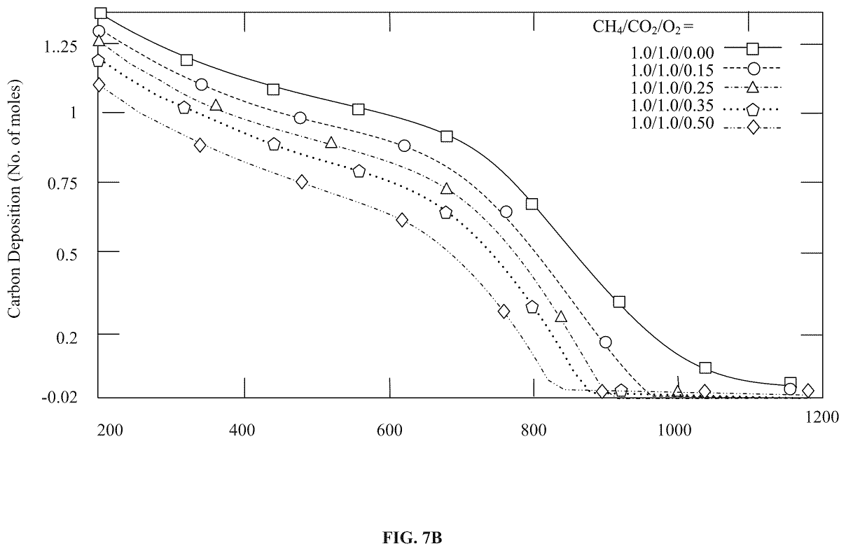

Reference is now made to FIG. 7A and FIG. 7B, which illustrate modeled results of the number of moles of carbon deposited versus temperature according to molar ratios of input gases to a single-vessel reactor, consistent with some embodiments of the present disclosure. FIG. 7A indicates that increasing an amount of H₂O decreases carbon formation and FIG. 7B indicates that increasing an amount of O₂ decreases carbon formation. The operating pressure for modeled results of FIG. 7A and FIG. 7B is 1 bar. Additionally, increasing an amount of H₂O and O₂ allows for lower temperatures to be utilized while maintaining a desirably low level of carbon formation in the single-vessel reactor. FIGS. 7A and 7B thus provide justification to modulate amounts of H₂O and/or O₂ to optimize carbon formation at lower temperatures.

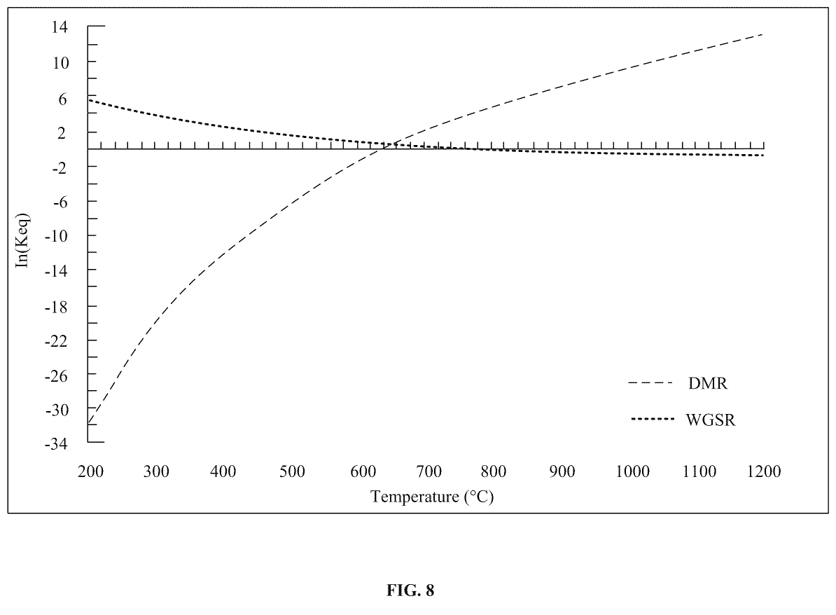

Reference is now made to FIG. 8, which illustrates modeled reaction rates of a DMR reaction and a water gas shift (WGS) reaction according to a temperature in a single-vessel reactor, consistent with some embodiments of the present disclosure. FIG. 8 illustrates that above a temperature of about 700° C., DMR is favored and the WGS reaction exhibits a negative ln(K_{eq}) value. This may indicate the reverse water gas shift reaction (e.g., Equation 1 from left to right) is favored above 700° C. Thus, FIG. 8 provides justification for operating conditions of a single-vessel reactor of the present disclosure such that synthesis gas with an ideal H₂:CO molar for chemicals production (e.g., H₂:CO from 1-2) may be generated.

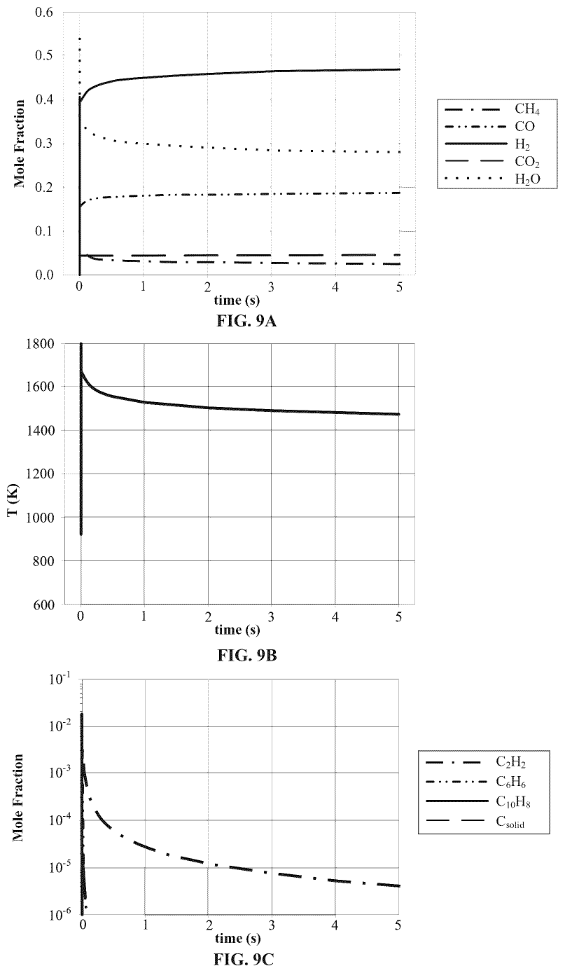

Reference is now made to FIGS. 9A-9C, which illustrate kinetic analyses for synthesis gas production in a conventional ATR reactor at conditions frequently employed in industry. The kinetic analyses illustrated in FIGS. 9A-9C were determined using Cantera software to simulate a composition profile of reactants and products (FIG. 9A), a temperature profile (FIG. 9B), and a soot precursor profile (FIG. 9C) for synthesis gas production based on reaction parameters. The reaction parameters input into the Cantera software to determine FIGS. 9A-9C include a CH₄:O₂:H₂O:CO₂ input with a composition of 1:0.55:0.6:0, an inlet temperature of 650° C., a pressure of 30 bar, a product syngas (H₂:CO) ratio of 2.5, and a soot precursor carbon solids (C_{solids}) equilibrium of 0.003. FIG. 9A illustrates that steady state is achieved rapidly, FIG. 9B illustrates a peak flame temperature of about 1800 K is simulated, and FIG. 9C illustrates that carbon soot precursors such as C₆H₆, C₁₀H₈, and C_{solids} are rapidly destroyed (e.g., rapidly drop to 0 mole fraction) whereas the C₂H₂ carbon soot precursor appears to achieve steady state at a mole fraction of about 10⁻⁶. Therefore, FIGS. 9A-9C provide a benchmark of synthesis gas production and soot formation to compare against the proposed tri-reforming process.

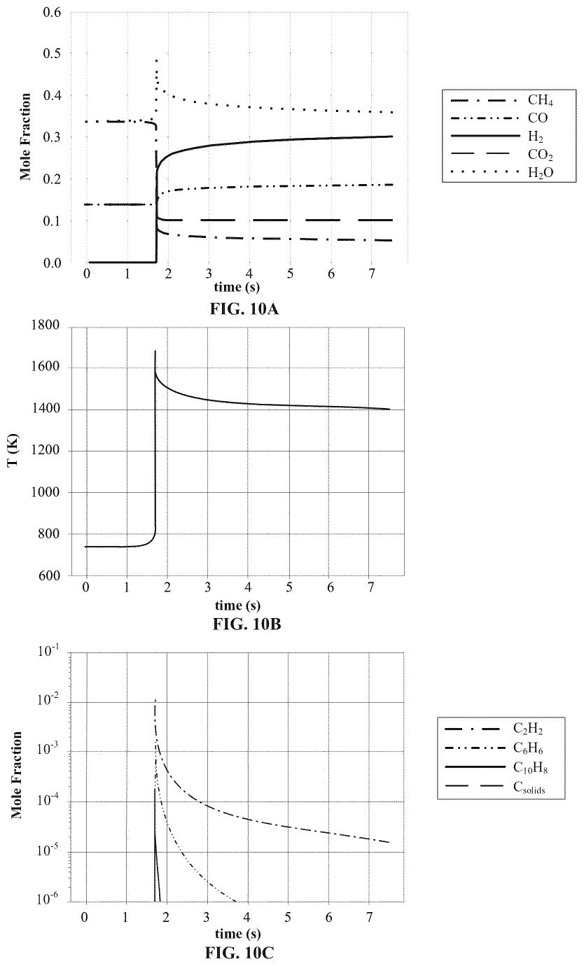

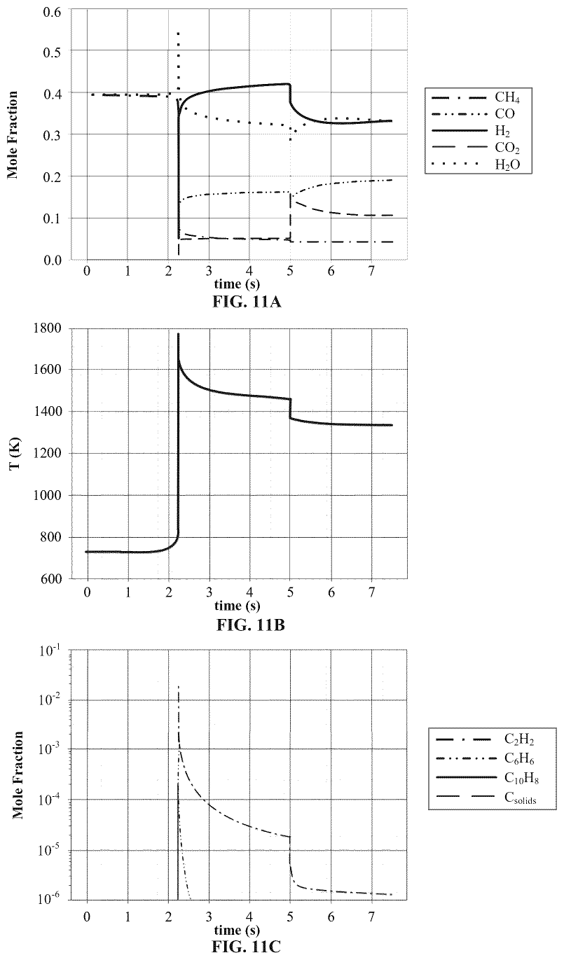

Reference is now made to FIGS. 10A-10C, which illustrate kinetic analyses for a CO₂ tri-reforming reaction in a single-vessel reactor, consistent with some embodiments of the present disclosure. The single-vessel reactor may be as described above, e.g., in FIG. 1 and FIG. 2. The CO₂ tri-reforming reaction may be as described above and may include, e.g., Equations 1-7. The kinetic analyses illustrated in FIGS. 10A-10C were determined using Cantera software to simulate a composition profile of reactants and products (FIG. 10A), a temperature profile (FIG. 10B), and a soot precursor profile (FIG. 10C) for a CO₂ tri-reforming reaction based on reaction parameters for feeding a separate CO₂ stream into a burner of the single-vessel reactor (e.g., into burner 104 in FIG. 1). The reaction parameters input into the Cantera software to determine FIGS. 10A-10C include a CH₄:O₂:H₂O:CO₂ input with a composition of 1:0.55:1:0.4, an inlet (CH₄, O₂, and H₂O) temperature of 450° C., an inlet CO₂ temperature of 523° C., a pressure of 30 bar, a product syngas (H₂:CO) ratio of 1.95, and a soot precursor carbon solids (C_{solids}) equilibrium of 0.008. The percentage of CO₂ recycled in the simulated system was set to 97%. FIG. 10A illustrates a simulated burner ignition of about 2 s after simulation start, and steady state is achieved rapidly. It should be noted that this ignition delay can be eliminated with proper burner design and during steady-state operation. FIG. 10B illustrates a peak flame temperature of about 1700 K and FIG. 10C illustrates a lower level of soot precursor destruction when compared to feeding CO₂ into a disengagement area of the single-vessel reactor (e.g., see FIG. 11C below). Feeding CO₂ into the burner of the reactor may provide a quenching effect to the partial oxidation reaction, which in turn may lower the peak flame temperature. A lower peak flame temperature may slow down a rate of carbon soot precursor destruction and result in soot carryover to the catalyst bed. FIGS. 10B and 10C thus may provide motivation to provide a larger flame area in the reactor (e.g., by increasing reactor size) such that greater residence time is provided for soot destruction. Alternatively, FIGS. 10B and 10C may provide motivation to increase the inlet temperature of CH₄, O₂, and CO₂ by, for example, incorporating a fuel fired heater system upstream of the reactor for the inlet feeds to the burner. Increasing pre-heat of feed streams to the burner may reduce the energy efficiency of the process and may increase overall CO₂ emissions and capital investment for pre-heat equipment, such a fuel fired furnace or electric heater.

Reference is now made to FIGS. 11A-11C, which illustrate kinetic analyses for a CO₂ tri-reforming reaction in a single-vessel reactor, consistent with some embodiments of the present disclosure. The single-vessel reactor may be as described above, e.g., in FIG. 1 and FIG. 2. The CO₂ tri-reforming reaction may be as described above and may include, e.g., Equations 1-7. The kinetic analyses illustrated in FIGS. 11A-11C were determined using Cantera software to simulate a composition profile of reactants and products (FIG. 11A), a temperature profile (FIG. 11B), and a soot precursor profile (FIG. 11C) for a CO₂ tri-reforming reaction based on reaction parameters for providing a separate CO₂ stream into a disengagement area of the single-vessel reactor (e.g., disengagement area 106 in FIG. 1). The reaction parameters input into the Cantera software to determine FIGS. 11A-11C include a CH₄:O₂:H₂O:CO₂ input with a composition of 1:0.55:1:0.4, an inlet (CH₄, O₂, and H₂O) temperature of 450° C., an inlet CO₂ temperature of 523° C., a pressure of 30 bar, a product syngas (H₂:CO) ratio of 1.95, and a soot precursor carbon solids (C_{solids}) equilibrium of 0.008. The percentage of CO₂ recycled in the simulated system was set to 97%. FIG. 11A illustrates a simulated burner ignition of about 2 s after simulation start, and then an abrupt change in composition profile after the separate CO₂ stream is fed into the single-vessel reactor at about 5 s. It should be noted that this ignition delay of approximately 2 s can be eliminated with reactor design (e.g., design of burner 104 in FIG. 1) and during steady-state operation. FIG. 11B illustrates a peak flame temperature of about 1800 K and then an abrupt decrease in process temperature at about 5 s when the CO₂ is fed into the single-vessel reactor. As described above, CO₂ has a temperature quenching effect to the CO₂ tri-reforming reactions. FIG. 11C illustrates an initial decrease in carbon soot precursor concentrations, and then a sudden decrease after feeding CO₂ into the single-vessel reactor. Notably, FIG. 11C demonstrates that feeding CO₂ into the single-vessel reactor into the disengagement area (e.g., disengagement area 106 of FIG. 1) further beneficially gasifies and destroys the carbon soot precursors and therefore reduces risk of carbon formation on the reactor catalyst. FIGS. 11B and 11C demonstrate that feeding a separate CO₂ stream into the single-vessel reactor in the partial oxidation zone downstream of the burner flame area and before the start of the catalytic zone (e.g., disengagement area 106 in FIG. 1) may beneficially maintain a hotter flame temperature, accelerate carbon soot precursor destruction comparable to a conventional ATR reactor with no CO₂ feed (e.g., FIGS. 9A-9C), and reduce an energy requirement of pre-heating inlet streams containing CH₄ and O₂ into the single-vessel rector. FIGS. 11A-11C also demonstrate low carbon carryover to the catalyst bed when part or all of the CO₂ input stream is fed to the disengagement area, compared to feeding CO₂ to the burner. Thus, FIGS. 11A-11C demonstrate a more energy-efficient process, lower CAPEX and OPEX costs, lower soot carbon formation, and lower overall CO₂ emissions compared to a conventional ATR system or tri-reforming system feeding CO₂ to burner.

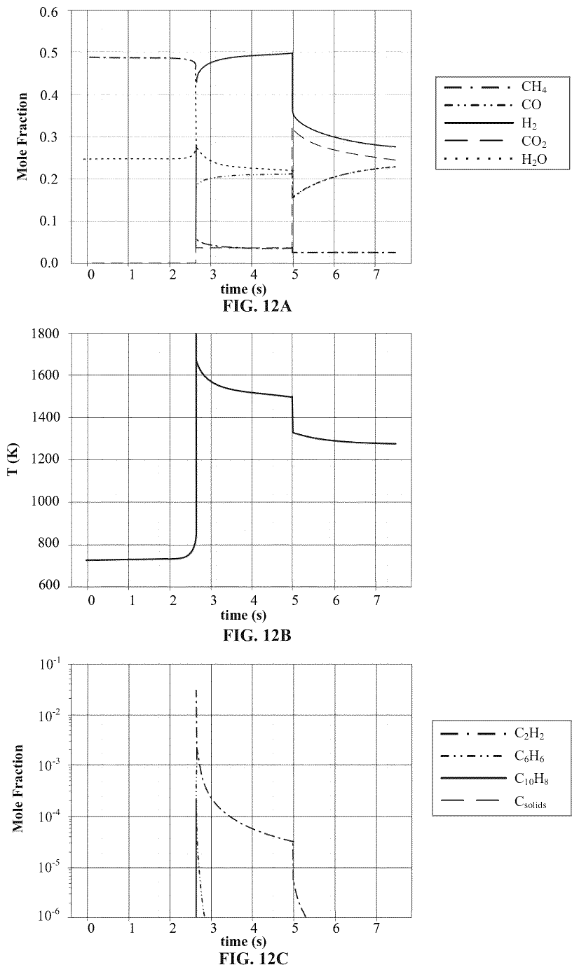

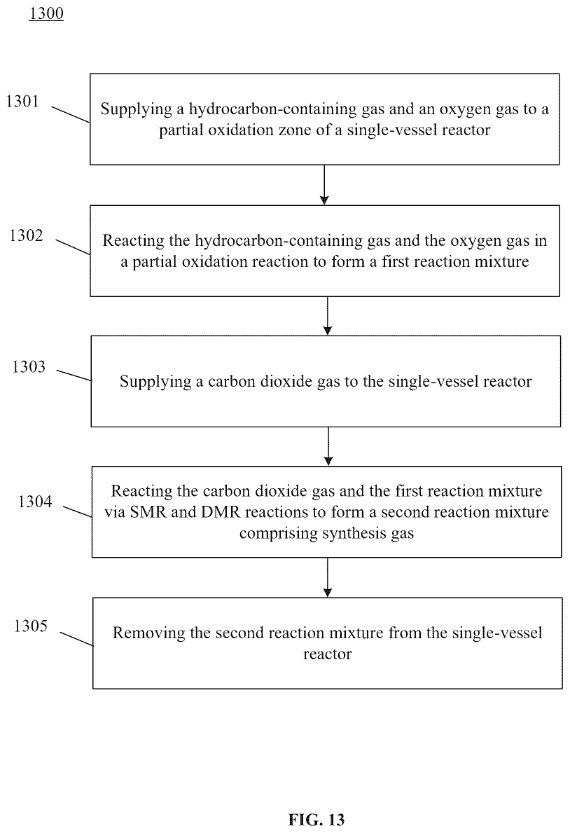

Reference is now made to FIGS. 12A-12C, which illustrate kinetic analyses for a CO₂ tri-reforming reaction in a single-vessel reactor, consistent with some embodiments of the present disclosure. The single-vessel reactor may be as described above, e.g., in FIG. 1 and FIG. 2. The CO₂ tri-reforming reaction may be as described above and may include, e.g., Equations 1-7. The kinetic analyses illustrated in FIGS. 12A-12C were determined using Cantera software to simulate a composition profile of reactants and products (FIG. 12A), a temperature profile (FIG. 12B), and a soot precursor profile (FIG. 12C) for a CO₂ tri-reforming reaction based on reaction parameters for providing a separate CO₂ stream into a disengagement area of the single-vessel reactor (e.g., disengagement area 106 in FIG. 1) for producing syngas with a ratio of approximately 1:1. The reaction parameters provided to the Cantera software to determine FIGS. 12A-12C include a CH₄:O₂:H₂O:CO₂ input with a composition of 1:0.55:0.5:1.33, an inlet (CH₄, O₂, and H₂O) temperature of 450° C., an inlet CO₂ temperature of 800° C., a pressure of 20 bar, a product syngas (H₂:CO) ratio of 1.0, and a soot precursor carbon solids (C_{solids}) equilibrium of 0.01. The percentage of CO₂ recycled in the simulated system was set to 143% (e.g., net-negative CO₂ import). FIG. 12A illustrates a simulated burner ignition of about 3 s after simulation start, and then an abrupt change in composition profile after the separate CO₂ stream is fed into the single-vessel reactor at about 5 s. It should be noted that this ignition delay of approximately 3 s can be eliminated with burner design and during steady-state operation. FIG. 12B illustrates a peak flame temperature of about 1800 K and then an abrupt decrease in process temperature at about 5 s when the CO₂ is fed into the single-vessel reactor. FIG. 12C illustrates an initial decrease in carbon soot precursor concentrations, and then a sudden decrease after feeding CO₂ into the single-vessel reactor. Notably, FIG. 12C demonstrates that feeding CO₂ into the single-vessel reactor (e.g., into the disengagement area 106 of FIG. 1) further gasifies and/or destroys the carbon soot precursors to a mole fraction below 106. FIGS. 12B and 12C thus demonstrate that net-negative CO₂ import can be achieved when feeding a separate CO₂ stream into the single-vessel reactor in the partial oxidation zone downstream of the burner flame area and before the start of the catalytic zone (e.g., disengagement area 106 in FIG. 1), and may maintain a hotter flame temperature, accelerate carbon soot precursor destruction compared to a conventional ATR reactor (e.g., FIGS. 9A-9C), and reduce an energy requirement of pre-heating inlet streams containing CH₄ and O₂ into the single-vessel reactor. FIGS. 12B and 12C also demonstrate that large volumes of CO₂ can be imported into the tri-reforming process for low syngas ratio, while minimizing soot formation to the catalyst bed.

Further disclosed herein are processes for generating synthesis gas using a single-vessel tri-reforming reactor. Reference is now made to FIG. 13, which is a flowchart for a process 1300 for generating synthesis gas using a single-vessel reactor, consistent with embodiments of the present disclosure. In step 1301, a hydrocarbon-containing gas and an oxygen gas are supplied to a partial oxidation zone of the single-vessel reactor. The hydrocarbon-containing gas may be supplied by a hydrocarbon-containing gas input (e.g., input 107 of FIG. 1 or input 202 of FIG. 2). The oxygen gas may be supplied by an oxygen gas input (e.g., input 108 of FIG. 1 or input 203 of FIG. 2). The hydrocarbon-containing gas may be any hydrocarbon-containing gas as described above, for example natural gas or methane.

In step 1302, the oxygen gas and the hydrocarbon-containing gas are reacted in a partial oxidation reaction in the partial oxidation zone to form a first reaction mixture. The molar ratios of oxygen to hydrocarbon in the gases may be as described above.

In step 1303, a carbon dioxide gas is supplied to the single-vessel reactor as described above. The carbon dioxide gas may be supplied via a carbon dioxide input (e.g., input 109 of FIG. 1 or input 204 of FIG. 2). The molar ratio of CO₂ to the other input gases may be as described above.

In step 1304, the carbon dioxide gas and the first reaction mixture are reacted in a SMR and rWGS reactions within a catalytic zone of the single-vessel reactor to form a second reaction mixture comprising synthesis gas. In some embodiments, the carbon dioxide and the first reaction mixture are also reacted via dry methane reforming (DMR) and methanation reactions within the catalytic zone. The catalytic zone may comprise a catalyst.

In step 1305, the second reaction mixture is removed from the single-vessel reactor.

The processes described herein may include all inputs, outputs, conditions, variables, and steps as described above with respect to the reactors and systems described herein.

As used herein, the term “about” shall generally mean an acceptable degree of error or variation for the quantity measured given the nature or precision of the measurements. Numerical quantities given in this description are approximate unless stated otherwise, meaning that the term “about” can be inferred when not expressly stated.

As used herein, the singular forms “a,” “an,” and “the” are intended to include the plural forms as well (i.e., at least one of whatever the article modifies), unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed herein could be termed a second feature or element, and similarly, a second feature or element discussed below could be termed a first feature or element without departing from the teachings of the disclosure.

The apparatuses, methods, and/or systems described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the apparatuses, methods, and/or systems in addition to those shown and described herein will become apparent to those skilled in the art from the foregoing description. Such modifications are also intended to fall within the scope of the appended claims.

1. A single-vessel reactor for conversion of carbon dioxide to synthesis gas, the single-vessel reactor comprising:
a partial oxidation zone comprising a burner to facilitate partial oxidation (POX);
a catalytic zone downstream from the partial oxidation zone comprising a catalyst to facilitate steam methane reforming (SMR) and reverse water gas shift (rWGS);
an input for supplying a hydrocarbon-containing gas to the partial oxidation zone;
an input for supplying oxygen to the partial oxidation zone;
an input for supplying carbon dioxide gas to the single-vessel reactor; and
an output from the catalytic zone for removing synthesis gas from the single-vessel reactor.

2. The single-vessel reactor of claim 1, wherein the burner of the partial oxidation zone comprises a flame with a flame area.

3. The single-vessel reactor of claim 2, wherein the partial oxidation zone comprises a disengagement area located downstream of the flame area and upstream of the catalytic zone.

4. The single-vessel reactor of claim 3, wherein the disengagement area is configured to facilitate mixing of the hydrocarbon-containing gas and the carbon dioxide gas.

5-7. (canceled)

8. The single-vessel reactor of claim 1, wherein the input for the carbon dioxide gas is configured to supply the carbon dioxide gas to the partial oxidation zone.

9. The single-vessel reactor of claim 1, wherein the input for the carbon dioxide gas is configured to supply the carbon dioxide gas through the burner.

10. The single-vessel reactor of claim 1, wherein the input for the carbon dioxide gas is configured to supply the carbon dioxide gas to a side of the single-vessel reactor.

11. The single-vessel reactor of claim 3, wherein the input for the carbon dioxide gas is configured to supply the carbon dioxide gas to the disengagement area.

12. The single-vessel reactor of claim 1, wherein the single-vessel reactor comprises an input for supplying steam to the single-vessel reactor.

13-16. (canceled)

17. The single-vessel reactor of claim 11, wherein the input for supplying carbon dioxide gas to the single-vessel reactor is configured to supply carbon dioxide recovered from a carbon dioxide hub.

18. (canceled)

19. The single-vessel reactor of claim 11, wherein the input for supplying carbon dioxide gas to the single-vessel reactor is configured to supply carbon dioxide recycled from the output from the catalytic zone.

20. The single-vessel reactor of claim 1, wherein the input for supplying carbon dioxide gas to the single-vessel reactor is configured to supply carbon dioxide that has been pre-heated before being supplied to the single-vessel reactor.

21. The single-vessel reactor of claim 1, wherein the input for supplying carbon dioxide gas to the single-vessel reactor is configured to supply carbon dioxide that has been pre-heated to a temperature ranging from about 900 to about 1600° F.

22. The single-vessel reactor of claim 1, wherein the amount of the oxygen supplied to the partial oxidation zone is sub stoichiometric compared to the amount of hydrocarbon within the hydrocarbon-containing gas supplied to the partial oxidation zone.

23. (canceled)

24. The single-vessel reactor of claim 1, wherein the molar ratio of the carbon dioxide gas supplied to the single-vessel reactor to the hydrocarbon in the hydrocarbon-containing gas supplied to the partial oxidation zone ranges from about 0.05 to about 1.

25. (canceled)

26. The single-vessel reactor of claim 1, wherein the synthesis gas in the output from the catalytic zone comprises a molar ratio of H₂ to CO ranging from about 1:1 to about 4:1.

27-28. (canceled)

29. The single-vessel reactor of claim 1, wherein the catalyst in the catalytic zone additionally facilitates at least one of methanation and dry methane reforming (DMR).

30-38. (canceled)

39. The single-vessel reactor of claim 11, wherein the carbon dioxide gas supplied to the single-vessel reactor comprises carbon dioxide recycled from the output from the catalytic zone, and wherein the single-vessel reactor is configured to convert from about 50 to about 97% of the carbon dioxide to synthesis gas upon a first and a second pass conversion through the reactor.

40. The single-vessel reactor of claim 1, wherein the single-vessel reactor is configured to capture heat generated in the partial oxidation zone and use the heat to pre-heat carbon dioxide supplied to the single-vessel reactor.

41-43. (canceled)

44. The single-vessel reactor of claim 1, wherein the single-vessel reactor is configured to capture heat generated by the output from the catalytic zone and use the heat to pre-heat carbon dioxide supplied to the single-vessel reactor.

45-116. (canceled)
